(19) United States
(12) Patent Application Publication
(10) Pub. No.: US 2017/0249092 A1
(43) Pub. Date: Aug. 31, 2017

(54) APPARATUS HAVING VOLATILE MEMORY, MEMORY CONTROL METHOD, AND STORAGE MEDIUM

(71) Applicant: CANON KABUSHIKI KAISHA, Tokyo (JP)

(72) Inventor: Yuichi Konosu, Saitama-shi (JP)

(21) Appl. No.: 15/435,056

(22) Filed: Feb. 16, 2017

(30) Foreign Application Priority Data
Feb. 25, 2016 (JP) 2016-034602
Jan. 6, 2017 (JP) 2017-000959

(51) Int. Cl. G06F 3/06

(52) U.S. Cl. CPC G06F 3/0619; G06F 3/0688; G06F 3/0655; G06F 3/065

(57) ABSTRACT

An apparatus includes a volatile memory for storing information, a flash memory having a program storage area for storing at least a program for controlling the apparatus, and a swap area for saving information read from the program storage area and loaded into the volatile memory, and a control unit configured to control processing for setting the flash memory to store information of one bit for one cell in a single level cell (SLC) scheme, in at least a part of the program storage area, and for setting the flash memory to store information of two or more bits for one cell in a multi level cell (MLC) scheme, in at least a part of the swap area, wherein the control unit is implemented by at least one processor.

### BACKGROUND OF THE INVENTION

Field of the Invention

The aspect of the embodiments relates to an apparatus, a memory control method, and a storage medium.

Description of the Related Art

In recent years, an increasing number of apparatuses have been provided with an embedded multi media card (eMMC) installed as a main storage. A NOT-AND (NAND) flash memory constituting the eMMC expresses information according to an amount of electric charges included in a cell. The cell is a minimum unit for storage. The NAND flash memories are roughly classified into two types depending on how the electric charges are included. A single level cell (SLC) can store information of one bit for one cell, and a multi level cell (MLC) can store information of two or more bits for one cell. As compared with the SLC, the MLC can store a larger amount of information (capacity). However, the MLC requires high accuracy in determination of information according to an amount of the electric charges, and thus easily deteriorates. Thus, as compared with the SLC, the MLC has such disadvantages that a limit of rewriting times is small, and a data storing (retention) period is short. Meanwhile, as compared with the MLC, the SLC stores a smaller amount of information (capacity), but is resistant to deterioration. Accordingly, the SLC has such an advantage that a limit of rewriting times is relatively large. In addition, the SLC also has such an advantage that a data storing (retention) period is long and thus data is not easily lost.

Meanwhile, an ordinary operating system (OS) uses a program storage area and a temporary area. The program storage area stores a program into a main storage, and the temporary area temporarily saves data such as data of a memory. The program storage area is an area for storing executable files of programs such as the OS and applications. A swap area is a representative example of the temporary area. The OS has a swap function of temporarily saving an unused program (process) to a swap area of a storage when the capacity of a physical memory is sufficient. For execution of the swap function, the swap area is to be secured beforehand in the main storage. Therefore, the main storage has a partition configuration including at least a program storage area for storing a program, and a swap area. In addition, in general, the swap area has a capacity about twice as large as the physical memory installed on an apparatus.

Japanese Patent Application Laid-Open No. 2011-186553 discusses a technique whereby, if an area for storing a program and a swap area are provided in a storage such as a NAND flash memory, data is guaranteed by monitoring a limit of the number of writing times, the number of reading times, or the number of deletion times.

However, if the swap area is secured on the eMMC, it may be an issue in that the capacity of the program storage area is insufficient or the program storing period of the program storage area is short.

### SUMMARY OF THE INVENTION

According to an aspect of the embodiments, an apparatus includes a volatile memory for storing information, a flash memory having a program storage area for storing at least a program for controlling the apparatus, and a swap area for saving information read from the program storage area and loaded into the volatile memory, and a control unit configured to control processing for setting the flash memory to store information of one bit for one cell in a single level cell (SLC) scheme, in at least a part of the program storage area, and for setting the flash memory to store information of two or more bits for one cell in a multi level cell (MLC) scheme, in at least a part of the swap area.

Further features of the present invention will become apparent from the following description of exemplary embodiments with reference to the attached drawings.

### BRIEF DESCRIPTION OF THE DRAWINGS

FIG. 1 is a block diagram illustrating a configuration example of an image forming apparatus.

FIG. 2 is a flowchart illustrating an example of processing for swap-out of an operating system (OS).

FIG. 3 is a flowchart illustrating an example of processing for swap-in of the OS.

FIGS. 4A and 4B are diagrams each illustrating an example of mode setting of an embedded multi media card (eMMC).

FIG. 5 is a diagram illustrating an example of mode setting of the eMMC.

FIG. 6 is a table illustrating a limit of rewriting times and a storing (retention) period.

### DESCRIPTION OF THE EMBODIMENTS

Various exemplary embodiments, features, and aspects of the disclosure will be described in detail below with reference to the drawings.

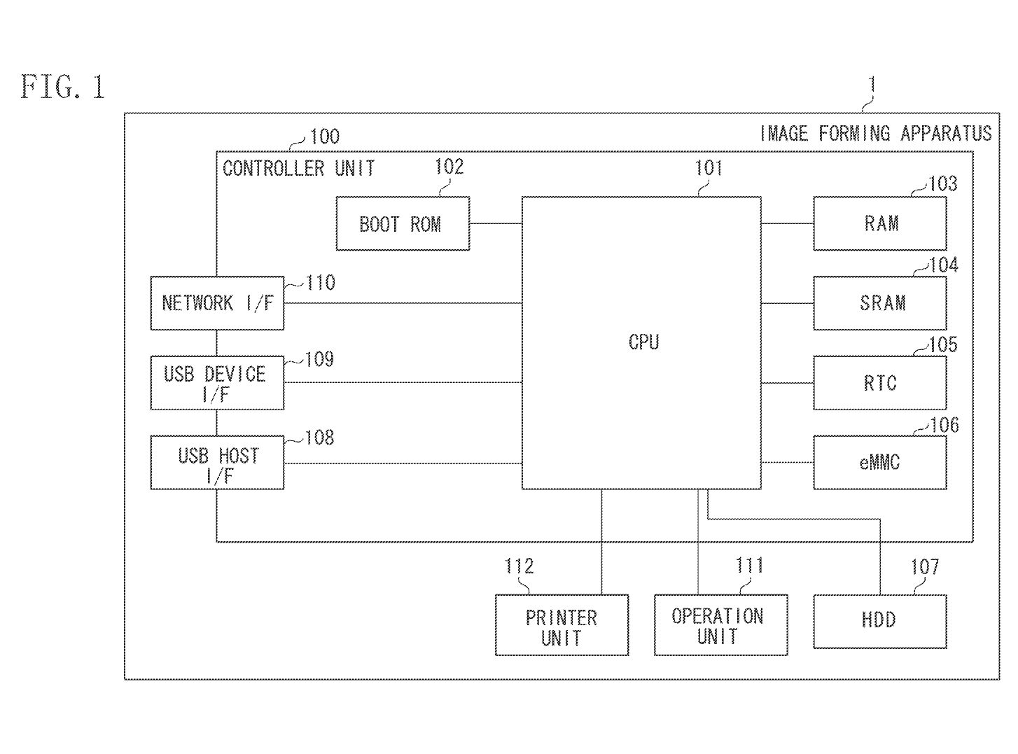

FIG. 1 is a block diagram illustrating a configuration example of an image forming apparatus 1 according to an exemplary embodiment of the disclosure. The image forming apparatus 1 is, for example, an information processing apparatus such as a printer. The image forming apparatus 1 includes a controller unit 100, a hard disk drive (HDD) 107, an operation unit 111, and a printer unit 112. The controller unit 100 is a general-purpose central processing unit (CPU) system, and controls each device and each unit. The HDD 107 is a removable storage for storing data. The operation unit 111 allows operation and display of the image forming apparatus 1. The printer unit 112 is an engine for outputting a digital image on paper.

The controller unit 100 includes a CPU 101, a boot read only memory (ROM) 102, a random access memory (RAM) 103, a static RAM (SRAM) 104, a real time clock (RTC) 105, an embedded multi media card (eMMC) 106, a Universal Serial Bus (USB) host interface (I/F) 108, a USB device I/F 109, and a network I/F 110. The CPU 101 controls the entire image forming apparatus 1. The boot ROM 102 is a memory for storing a boot program for start-up. The RAM 103 is a memory to be used by the CPU 101 as a work memory, and stores information. The SRAM 104 is a memory capable of storing data such as setting information required for operating the image forming apparatus 1 even when power supply is interrupted. The RTC 105 has a clock function. The eMMC 106 is a NAND flash memory, and stores programs including an OS to be executed by the CPU 101, and various data. The CPU 101 uses the eMMC 106 as a main storage, and the HDD 107 as a substorage. The USB host I/F 108 is an interface connectable to USB devices such as a USB memory and a USB card reader. The USB device I/F 109 is an interface connectable to an external apparatus via a USB cable. The network I/F 110 is an interface connectable to an external network via a wired LAN or a wireless LAN. The CPU 101 includes CPU peripheral hardware such as a chipset, a bus bridge, and a clock generator.

An operation of the controller unit 100 will be described taking image printing on paper as an example. The controller unit 100 inputs an instruction for printing an image of image data from the external apparatus such as a PC or a USB memory via each I/F, according to a user operation. The CPU 101 then performs direct memory access (DMA) transfer of the input image data to the RAM 103. The RAM 103 temporarily stores this digital image data. When confirming completion of the transfer of a certain amount or all of the digital image data to the RAM 103, the CPU 101 outputs an image-output instruction to the printer unit 112. When the CPU 101 specifies the position of the image data on the RAM 103, the image data on the RAM 103 is transmitted to the printer unit 112, according to a synchronization signal from the printer unit 112. The printer unit 112 then performs printing for the received digital image data, on paper. When printing is to be performed for a plurality of sets, the CPU 101 stores the image data stored on the RAM 103 into the eMMC 106 or the HDD 107. This enables the CPU 101 to transmit the image data to the printer unit 112, without requesting the image from the external apparatus, when performing printing for the second and subsequent sets.

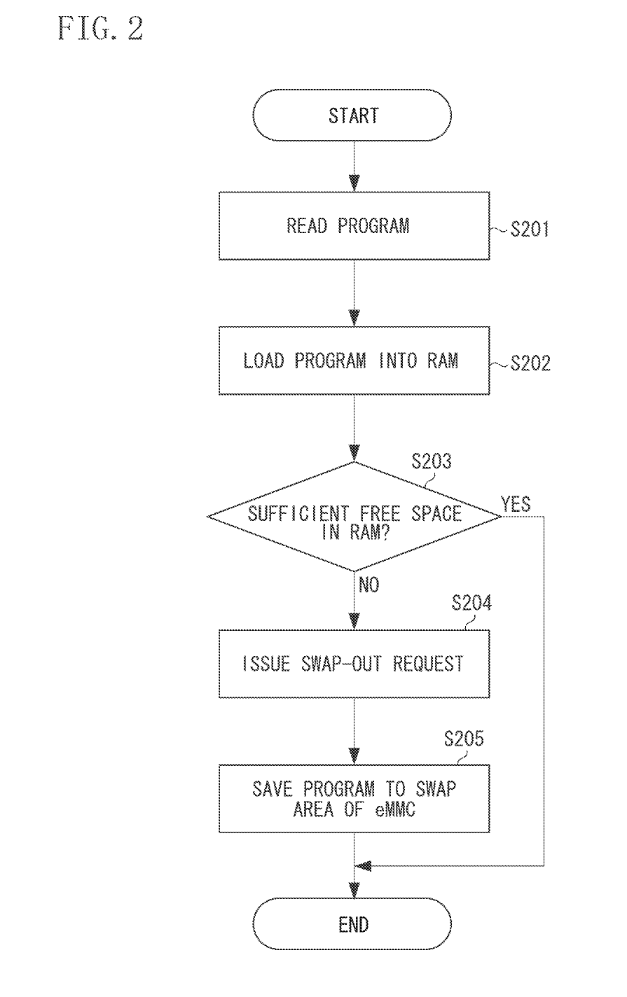

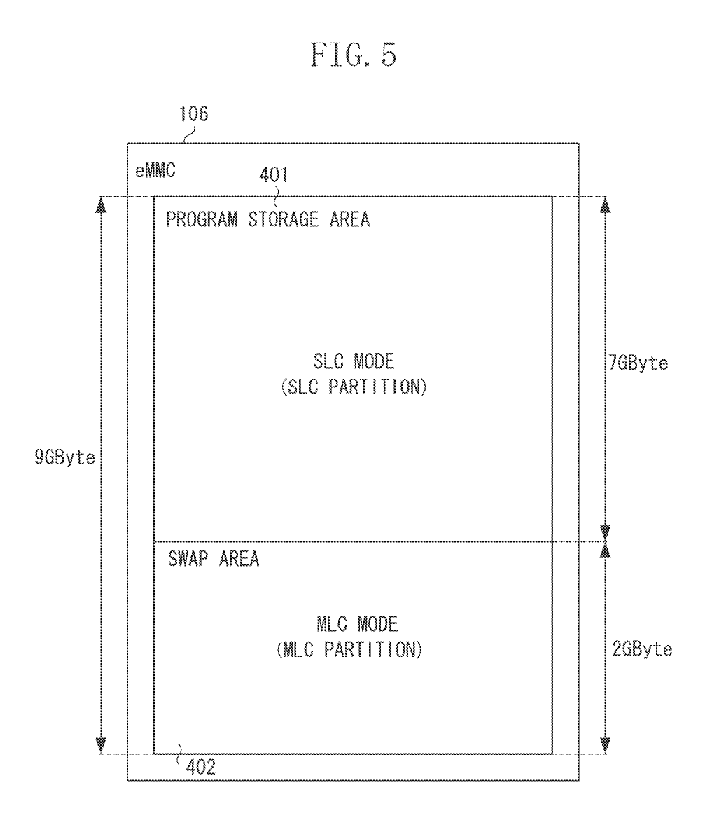

FIG. 2 is a flowchart illustrating an example of processing for swap-out of the OS executed by the CPU 101. The swap-out is a swap function of temporarily saving an unused program (process) stored on the RAM 103 to a swap area of the eMMC 106 when the memory capacity of the RAM 103 is insufficient. The eMMC 106 includes a program storage area 401 and a swap area 402, as illustrated in FIG. 5. The program storage area 401 stores programs such as the OS and applications. The swap area 402 temporarily saves data such as data of a memory.

First, in step S201, the CPU 101 reads a program stored in the program storage area 401 of the eMMC 106. Next, in step S202, the CPU 101 loads (writes) the read program into the RAM 103, and then executes this program. Subsequently, in step S203, the CPU 101 determines whether there is sufficient free space in the RAM 103. When there is no sufficient free space in the RAM 103 (NO in step S203), the processing proceeds to step S204. When there is sufficient free space in the RAM 103 (YES in step S203), the processing ends. In step S204, the CPU 101 issues a swap-out request for swap-out to be performed by the OS. Next, in step S205, following the issuance of the swap-out request, the CPU 101 temporarily saves (writes) an unused program (unnecessary information) stored in the RAM 103, to the swap area 402 secured beforehand on the eMMC 106.

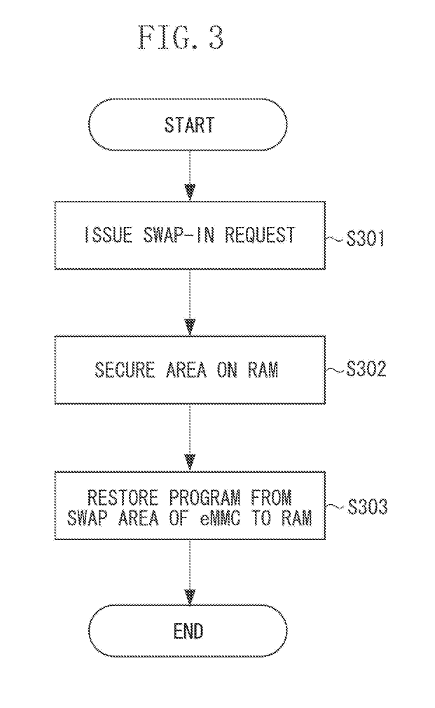

FIG. 3 is a flowchart illustrating an example of processing for swap-in of the OS executed by the CPU 101. The swap-in is a swap function of restoring the program saved to the swap area 402 of the eMMC 106 to the RAM 103.

First, in step S301, the CPU 101 issues a swap-in request for swap-in to be performed by the OS, when executing the swapped-out program again. Next, in step S302, according to the issued swap-in request, the CPU 101 secures an area on the RAM 103 to execute the program. Subsequently, in step S303, the CPU 101 reads the program from the swap area 402 of the eMMC 106, and restores (loads or writes) the read program, to the area secured on the RAM 103 in step S302. The CPU 101 then executes the program loaded into the RAM 103.

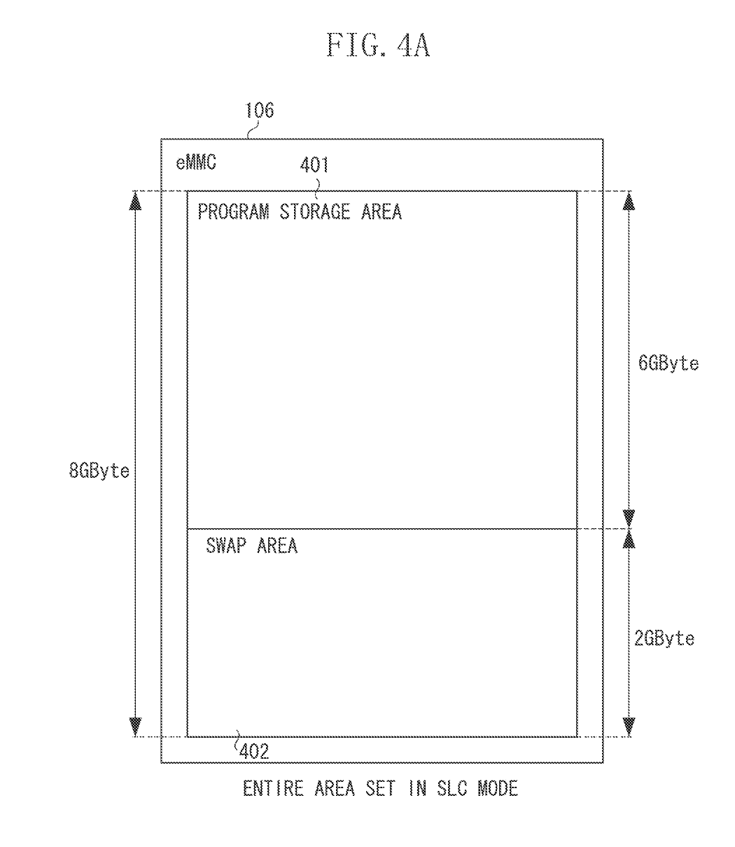

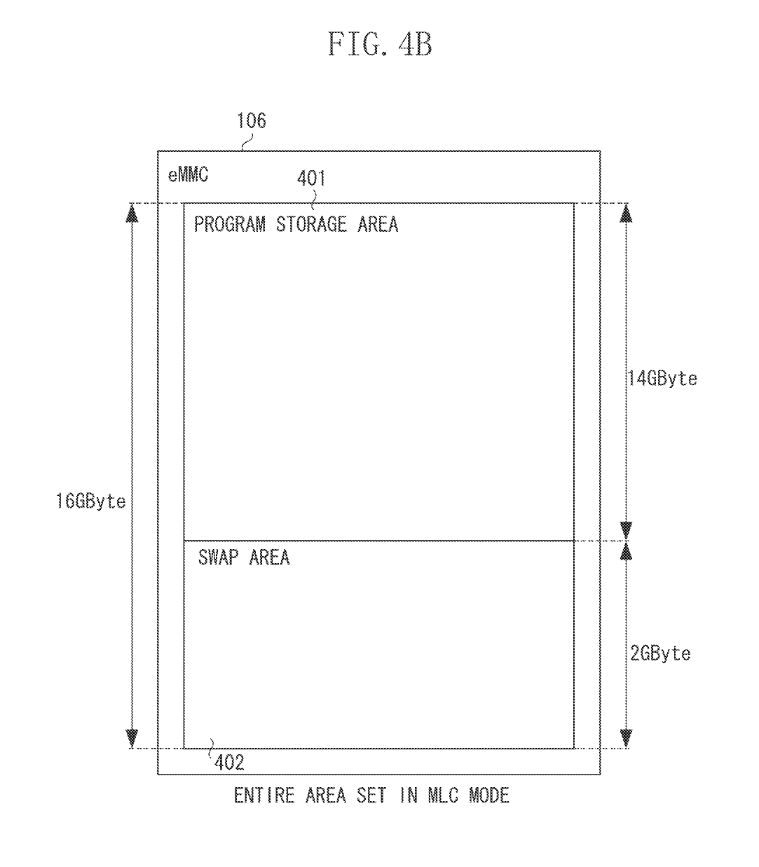

FIG. 4A is a diagram illustrating an example of SLC mode setting of the eMMC 106. The eMMC 106 has the program storage area 401 and the swap area 402. The entire area including the program storage area 401 and the swap area 402 is set in an SLC mode. In the SLC mode, information of one bit can be stored for one cell. Assume that the RAM 103 has a capacity of one gigabyte, and the eMMC 106 has a capacity of eight gigabytes when the entire area thereof is in the SLC mode, and this case will be used as an example to simplify the description. Since the RAM 103 has the capacity of one gigabyte, the swap area 402 of the eMMC 106 has a capacity of two gigabytes, which is double the capacity of the RAM 103. The eMMC 106 has the capacity of eight gigabytes when the entire area thereof is in the SLC mode. Thus, when the swap area 402 has the capacity of two gigabytes, the eMMC 106 has the remaining capacity of six gigabytes, i.e., the program storage area 401 has a capacity of six gigabytes, in the SLC mode. However, a storable amount of information (capacity) in the SLC mode is smaller than that in an MLC mode. The capacity of the program storage area 401, i.e., six gigabytes, is therefore relatively small, which may be an issue.

FIG. 4B is a diagram illustrating an example of MLC mode setting of the eMMC 106. The entire area including the program storage area 401 and the swap area 402 is set in the MLC mode. In the MLC mode, information of two or more bits can be stored for one cell. Assume that the RAM 103 has a capacity of one gigabyte, and the eMMC 106 has a capacity of sixteen gigabytes when the entire area thereof is in the MLC mode, and this case will be described as an example. Since the RAM 103 has the capacity of one gigabyte, the swap area 402 of the eMMC 106 has a capacity of two gigabytes, which is double the capacity of the RAM 103. The eMMC 106 has the capacity of sixteen gigabytes when the entire area thereof is in the MLC mode. Thus, when the swap area 402 has the capacity of two gigabytes, the eMMC 106 has the remaining capacity of fourteen gigabytes, i.e., the program storage area 401 has a capacity of fourteen gigabytes, in the MLC mode. In the MLC mode, a storable amount of information (capacity) is large, but a limit of rewriting times is small, and a data storing (retention) period is short, as compared with the MLC mode. For this reason, the program storage area 401 may have such a situation that there is a high possibility of losing a program to be stored.

FIG. 5 is a diagram illustrating an example of mode setting of the eMMC 106, according to the present exemplary embodiment. The eMMC 106 has the program storage area 401 and the swap area 402, and can be set in the SLC mode or the MLC mode for each of the areas. Information of one bit can be stored for one cell in the SLC mode, whereas information of two or more bits can be stored for one cell in the MLC mode. In the MLC mode, the amount of storable information (capacity) is large, the limit of rewriting times is small, and the data storing (retention) period is short, as compared with the SLC mode. In contrast, in the SLC mode, the amount of storable information (capacity) is small, the limit of rewriting times is large, and the data storing (retention) period is long, as compared with the MLC mode. The program storage area 401 stores a program to be executed by the CPU 101. The swap area 402 is an area for saving the information (program) stored in the RAM 103.

The swap area 402 is set in the MLC mode to increase the capacity of the program storage area 401. When the RAM 103 has a capacity of one gigabyte, the swap area 402 of the eMMC 106 has a capacity of two gigabytes, which is double the capacity of the RAM 103. The program storage area 401 is set in the SLC mode, in order to increase a period for storing (retaining) a program to be stored in the program storage area 401. In the SLC mode, the program storage area 401 has a capacity of seven gigabytes, which is half the capacity of fourteen gigabytes when the MLC mode illustrated in FIG. 4B is set. In other words, the program storage area 401 is set in the SLC mode and has the capacity of seven gigabytes. The swap area 402 is set in the MLC mode and has the capacity of two gigabytes. The eMMC 106 has the program storage area 401 of seven gigabytes and the swap area 402 of two gigabytes, and has a capacity of nine gigabytes in total.

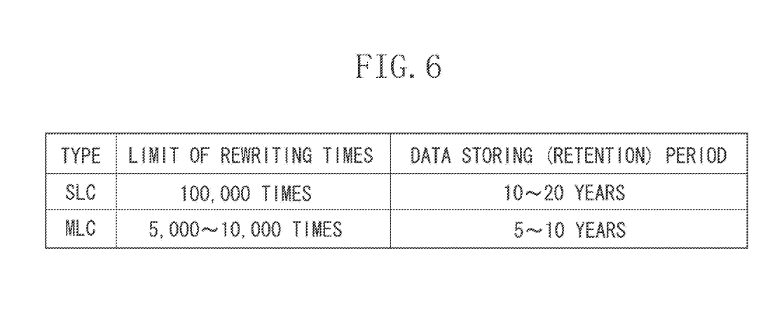

FIG. 6 is a table illustrating the limit of rewriting times and the data storing (retention) period in each of the SLC mode and the MLC mode of the eMMC 106 configured of the NAND flash memory. The limit of rewriting times in the SLC mode is larger than that in the MLC mode. The data storing (retention) period in the SLC mode is longer than that in the MLC mode. Thus, the SLC mode can improve reliability of data storing, as compared with the MLC mode.

Since the program storage area 401 is set in the SLC mode, the period for storing (retaining) a program to be stored is long, as compared with a case where the program storage area 401 is set in the MLC mode. It is therefore possible to guarantee reliability of storage of the program. In the case where the program storage area 401 and the swap area 402 are set in the SLC mode as illustrated in FIG. 4A, the capacity of the program storage area 401 is six gigabytes. In contrast, in the case illustrated in FIG. 5 of the present exemplary embodiment, the swap area 402 is set in the MLC mode. Thus, the capacity of the program storage area 401 is seven gigabytes, which can be larger than that in the case illustrated in FIG. 4A.

In the present exemplary embodiment, the program storage area 401 is set in the SLC mode, and the swap area 402 is set in the MLC mode, as illustrated in FIG. 5. It is therefore possible to secure a sufficient capacity for the program storage area 401 and the swap area 402. In addition, since the program storage area 401 is in the SLC mode in which the data storing period is long, a program can be stored in an area where a data storing period is long. Therefore, the possibility of losing a program to be stored can be reduced, and thus the reliability of storage of the program can be guaranteed.

Here, different models of apparatuses of the same type may be used depending on physical memory or eMMC capacity. For example, as for image forming apparatuses, a high-end model and a low-end model may have the respective physical memories having the same capacity of one gigabyte. However, as for the eMMC capacity (when the entire area is set in the MLC mode), the high-end model may be installed with an eMMC of a capacity of sixteen gigabytes, whereas the low-end model may be installed with an eMMC of a capacity of eight gigabytes. The high-end model can therefore store more programs than the low-end model. However, the installed physical memories have the same capacities of one gigabyte. Therefore, a swap area that is double the physical memory can be secured in the high-end model, but a swap area of a similar size cannot be secured in the low-end model. This is because, if a swap area of this size is secured in the low-end model, a program storage area is squeezed. In that case, it is conceivable that, instead of a typical swap area that is double the physical memory, an area having a capacity to the extent of not squeezing the program storage area, e.g., one gigabyte, may be set as an MLC area in the eMMC and secured as the swap area, in the low-end model. In this case, a non-swap area of the eMMC can be set as an SLC area.

Here, if a hardware configuration allows a change in the eMMC from eight gigabytes to sixteen gigabytes, it is possible to change from the low-end model to the high-end model by changing the eMMC. In this case, in the present exemplary embodiment, if the capacity of the eMMC is sixteen gigabytes and sufficient, two gigabytes, which is double the physical memory, can be set as an MLC area in the eMMC to be allocated as a swap area.

A non-swap area of the eMMC can be set as an SLC area, in this case as well.

In this way, the CPU 101 executes a setting process for a RAM, so as to change the storage capacity of a swap area for storing information in the MLC scheme, based on the capacity of the RAM serving as an example of a volatile memory.

The image forming apparatus 1 is described above as an example. However, the present technology is applicable to various information processing apparatuses, e.g., a personal computer (PC), a mobile terminal such as a smartphone, and a server, without being limited to the image forming apparatus 1. In addition, the eMMC 106 is described as an example of the NAND flash memory. However, the present exemplary embodiment is not limited to this example, and is applicable to, for example, a solid state drive (SSD) or a USB memory.

Moreover, any of exemplary embodiments described above only exemplifies an embodiment in carrying out the disclosure, and the technical scope of the disclosure shall not be interpreted in a limited way. In other words, the disclosure can be carried out in various forms, without deviating from the technical ideas or the substantial features thereof.

A capacity sufficient for a program storage area can be secured, and a program storing period of a program storage area can be extended. Reliability can therefore be enhanced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, eMMC (Embedded Multi Media Card), and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2016-034602, filed Feb. 25, 2016, and No. 2017-000959, filed Jan. 6, 2017, which are hereby incorporated by reference herein in their entirety.

What is claimed is:

1. An apparatus comprising:
a volatile memory for storing information;
a flash memory having a program storage area for storing at least a program for controlling the apparatus, and a swap area for saving information read from the program storage area and loaded into the volatile memory; and
a control unit configured to control processing for setting the flash memory to store information of one bit for one cell in a single level cell (SLC) scheme, in at least a part of the program storage area, and for setting the flash memory to store information of two or more bits for one cell in a multi level cell (MLC) scheme, in at least a part of the swap area,
wherein the control unit is implemented by at least one processor.

2. The apparatus according to claim 1, wherein the control unit reads a program stored in the program storage area, and writes the read program into the volatile memory.

3. The apparatus according to claim 1, wherein, in a case where there is not sufficient free space in the volatile memory, the control unit saves unnecessary information stored in the volatile memory to the swap area.

4. The apparatus according to claim 1, wherein the control unit reads information saved to the swap area, and restores the read information to the volatile memory.

5. The apparatus according to claim 1,
wherein the control unit reads a program stored in the program storage area, and writes the read program into the volatile memory,
wherein, in a case where there is not sufficient free space in the volatile memory, the control unit saves an unnecessary program stored in the volatile memory to the swap area according to a swap-out request, and
wherein the control unit reads a program saved to the swap area and restores the read program to the volatile memory according to a swap-in request.

6. The apparatus according to claim 1, wherein the flash memory is an embedded multi media card (eMMC).

7. The apparatus according to claim 1, further comprising a printer unit configured to print image data stored in the volatile memory.

8. The apparatus according to claim 1, wherein the control unit performs setting processing for the volatile memory so that a storage capacity of the swap area for storing information in the MLC scheme is changed based on a capacity of the volatile memory.

9. A method for an apparatus including a volatile memory for storing information, and a flash memory that has a program storage area for storing at least a program for controlling the apparatus and a swap area for saving information read from the program storage area and loaded into the volatile memory, the method comprising:
setting the flash memory to store information of one bit for one cell in a SLC scheme, in at least a part of the program storage area; and
setting the flash memory to store information of two or more bits for one cell in an MLC scheme, in at least a part of the swap area.

10. The method according to claim 9, further comprising:
reading a program stored in the program storage area; and
writing the read program into the volatile memory.

11. The method according to claim 9, further comprising saving unnecessary information stored in the volatile memory to the swap area, in a case where there is not sufficient free space in the volatile memory.

12. The method according to claim 9, further comprising:
reading information saved to the swap area; and
restoring the read information to the volatile memory.

13. The method according to claim 9, further comprising:
reading a program stored in the program storage area;
writing the read program into the volatile memory;
saving an unnecessary program stored in the volatile memory to the swap area according to a swap-out request, in a case where there is not sufficient free space in the volatile memory; and
reading a program saved to the swap area and restoring the read program to the volatile memory according to a swap-in request.

14. The method according to claim 9, wherein the flash memory is an embedded multi media card (eMMC).

15. The method according to claim 9, further comprising performing setting processing for the volatile memory so that a storage capacity of the swap area for storing information in the MLC scheme is changed based on a capacity of the volatile memory.

16. A computer readable storage medium storing computer-executable program of instructions for causing a computer to perform a method for an apparatus including a volatile memory for storing information, and a flash memory that has a program storage area for storing at least a program for controlling the apparatus and a swap area for saving information read from the program storage area and loaded into the volatile memory, the method comprising:
setting the flash memory to store information of one bit for one cell in a SLC scheme, in at least a part of the program storage area; and
setting the flash memory to store information of two or more bits for one cell in an MLC scheme, in at least a part of the swap area.

17. The computer readable storage medium according to claim 16, further comprising:
reading a program stored in the program storage area; and
writing the read program into the volatile memory.

18. The computer readable storage medium according to claim 16, further comprising saving unnecessary information stored in the volatile memory to the swap area, in a case where there is not sufficient free space in the volatile memory.

19. The computer readable storage medium according to claim 16, further comprising:
reading information saved to the swap area; and
restoring the read information to the volatile memory.

20. The computer readable storage medium according to claim 16, further comprising:
reading a program stored in the program storage area;
writing the read program into the volatile memory;
saving an unnecessary program stored in the volatile memory to the swap area according to a swap-out request, in a case where there is not sufficient free space in the volatile memory; and
reading a program saved to the swap area and restoring the read program to the volatile memory according to a swap-in request.
